(19) United States
(12) Patent Application Publication
(10) Pub. No.: US 2022/0366467 A1
(43) Pub. Date: Nov. 17, 2022

(54) INFORMATION PROCESSING APPARATUS, INFORMATION PROCESSING METHOD, AND NON-TRANSITORY COMPUTER-READABLE MEDIUM

(71) Applicant: TOYOTA JIDOSHA KABUSHIKI KAISHA, Toyota-shi (JP)

(72) Inventors: Yuta TONE, Nagoya-shi (JP); Yukinori II, Toyota-shi (JP); Tadayuki TANAKA, Nagoya-shi (JP); Naoki ISHIZUKA, Nagoya-shi (JP); Yuichiro YANO, Nagakute-shi (JP); Nariaki AMANO, Nagoya-shi (JP); Yusuke MAEDA, Miyoshi-shi (JP); Kei YAZAKI, Okazaki-shi (JP); Yu HAMADA, Nagoya-shi (JP)

(73) Assignee: TOYOTA JIDOSHA KABUSHIKI KAISHA, Toyota-shi (JP)

(21) Appl. No.: 17/739,952

(22) Filed: May 9, 2022

(30) Foreign Application Priority Data
May 13, 2021 (JP) 2021-081756

(51) Int. Cl. G06Q 30/02

(52) U.S. Cl. CPC G06Q 30/0283

(57) ABSTRACT

A controller of the information processing apparatus calculates a sale price of a second component selected to be sold by a user of a vehicle, based on information indicating a value of the second component, and subtracts the sale price of the second component from a cost of installing a first component. The second component is either a component bound to be removed from the vehicle when installing the first component in the vehicle other than a component to be replaced with the first component, or a component bound to be removed from the vehicle when the first component is installed in the vehicle in a case where there is no component to be replaced with the first component in the vehicle.

### CROSS-REFERENCE TO RELATED APPLICATION

This application claims the benefit of Japanese Patent Application No. 2021-081756, filed on May 13, 2021, which is hereby incorporated by reference herein in its entirety.

### BACKGROUND OF THE INVENTION

### 1. Field

The present disclosure relates to an information processing apparatus, an information processing method, and a non-transitory computer-readable medium.

### 2. Description of the Related Art

Techniques for updating software of electronic controllers (ECUs) mounted in vehicles have hitherto been known (e.g., WO 2019/009020).

### SUMMARY

An object of the present disclosure is to provide an information processing apparatus, an information processing method, and a non-transitory computer-readable medium, which can help encourage installation of equipment in vehicles.

One aspect of the present disclosure is an information processing apparatus including a controller that calculates a sale price of a second component selected to be sold by a user of a vehicle, based on information indicating a value of the second component, and subtracts the sale price of the second component from a cost of installing a first component, the second component being either a component bound to be removed from the vehicle when installing the first component in the vehicle other than a component to be replaced with the first component, or a component bound to be removed from the vehicle when the first component is installed in the vehicle in a case where there is no component to be replaced with the first component in the vehicle.

One aspect of the present disclosure is an information processing method including the steps, performed by an information processing apparatus, of: calculating a sale price of a second component selected to be sold by a user of a vehicle, based on information indicating a value of the second component, and subtracting the sale price of the second component from a cost of installing a first component, the second component being either a component bound to be removed from the vehicle when installing the first component in the vehicle other than a component to be replaced with the first component, or a component bound to be removed from the vehicle when the first component is installed in the vehicle in a case where there is no component to be replaced with the first component in the vehicle.

One aspect of the present disclosure is a program that causes a computer to execute the steps of calculating a sale price of a second component selected to be sold by a user of a vehicle, based on information indicating a value of the second component, and subtracting the sale price of the second component from a cost of installing a first component, the second component being either a component bound to be removed from the vehicle when installing the first component in the vehicle other than a component to be replaced with the first component, or a component bound to be removed from the vehicle when the first component is installed in the vehicle in a case where there is no component to be replaced with the first component in the vehicle.

One aspect of the present disclosure may include, besides the information processing apparatus, information processing method, and program described above, at least one of an information processing system including the information processing apparatus described above, and a non-transitory computer-readable medium in which the program described above is recorded.

The present disclosure can help encourage installation of equipment in vehicles.

### BRIEF DESCRIPTION OF THE DRAWINGS

FIG. 1 is a schematic diagram of an information processing system according to an embodiment;

FIG. 2 is a diagram illustrating a configuration example of a terminal device usable as a server 3 and a terminal 2;

FIG. 3 is a flowchart illustrating an example of processing in the terminal 2;

FIG. 4 illustrates one example of operation sheet for installing a component X in a vehicle;

FIG. 5 is a flowchart illustrating an example of processing for calculating a sale price of a first sale item;

FIG. 6A is a chart showing a data structure example of a component database stored in the terminal 2, and FIG. 6B is a chart showing an example of a component management table managed in the server 3;

FIG. 7 is a flowchart illustrating an example of processing for calculating a sale price of a second sale item;

FIG. 8 is a flowchart illustrating an example of processing for calculating a sale price of a third sale item; and

FIG. 9 illustrates a corrected version of the operation sheet.

### DESCRIPTION OF THE PREFERRED EMBODIMENTS

An information processing apparatus according to the embodiment includes a controller that calculates a sale price of a second component selected to be sold by a user of a vehicle, based on information indicating a value of the second component, and subtracts the sale price of the second component from a cost of installing a first component, the second component being either a component bound to be removed from the vehicle when installing the first component in the vehicle other than a component to be replaced with the first component, or a component bound to be removed from the vehicle when the first component is installed in the vehicle in a case where there is no component to be replaced with the first component in the vehicle.

According to the information processing apparatus, when a first component is to be installed in a vehicle and a second component is to be sold, the sale price can be subtracted from the cost of installing the first component. Since the cost required for the installation of the first component can be reduced this way, installation of equipment (first component) in the vehicle can be encouraged.

The first component here may be of any kind. Examples of the first component include advanced safety systems (such as collision damage mitigating brake, false start prevention control, adaptive cruise control, lane keeping control, rear cross-traffic alert, and automatic headlight switch). The first component can also include, for example, AV equipment, car navigation, or communication equipment built in the vehicle. The first component also includes optional items to be fitted in place of parts bound to be installed as standard items when the vehicle is assembled. The optional items can include, for example, a hood, sliding roof, sheet, fender, suspension, muffler, and so on.

When, for example, a communication device is replaced with a next generation model, this communication device to be replaced is removed after removing the instrument panel in the vehicle, and after removing the components surrounding the communication device. Sometimes, a display, wireless charger, GPS splitter, or audio amplifier and the like disposed inside the instrument panel may be in the way of removing the communication device so that the target communication device cannot be removed unless these parts are removed first. Normally, after removing the communication device to be replaced from the vehicle and installing a new communication device, the components that were removed are reinstalled in the reverse order of when they were removed. Some of the removed components at this time (e.g., wireless charger) may not require reinstallation for a reason such as because it is not being used, and may even be sellable. If the sale profit from this component can be applied to the cost (such as operation fee) for installing the communication device, it will be easier for the user of the vehicle to make a decision to replace (or equip) the communication device. The information processing apparatus according to the embodiment supports such sale of components.

In the present application, the “second component” is, for example, a component other than a component to be replaced with the first component, and selected to be sold by the user of the vehicle. The component to be replaced is, for example, a component having the same function as that of the first component, such as the communication device described above. This includes a case where, while the function (communication function) is the same, the communication method is different between generations (e.g., LTE and 5G). In the case of the replacement of a communication device described above, a display, wireless charger, GPS splitter, or audio amplifier and the like, which are removed from the vehicle when the communication device to be replaced is removed, are the “component other than a component to be replaced,” and a component among them selected (determined) to be sold by the user is the second component. The component to be replaced is not categorized as the second component and may or may not be designated as a sale target.

The second component may also be a component that is selected to be sold by the user of the vehicle and that is bound to be removed from the vehicle when the first component is installed in the vehicle in a case where there is no component to be replaced with the first component in the vehicle. Namely, the first component may be not only a component that is to replace another component already installed in the vehicle, but also a component that adds a new function to the vehicle, for example. An applicable case would be, for example, where the vehicle is not equipped with a communication device, and a communication device as a first component is newly mounted (installed). In this case, there is no component to be replaced in the vehicle, and any component that is removed from the vehicle in order to install the communication device that is a new component is the “second component.” In this case, too, the sale profit from the second component would encourage installation of the first component in the vehicle.

In the information processing apparatus according to the embodiment, the second component may include a first sale item, which is a component removed from the vehicle in an operation of installing the first component in the vehicle. For example, there is a case where the first component is a communication device, and the communication device to be replaced is removed after removing, for example, an audio amplifier and a wireless charger, in the operation of replacing the communication device. In this case, one of the audio amplifier and wireless charger selected by the user to be sold is the first sale item.

In the information processing apparatus according to the embodiment, the second component may include a second sale item, which is a vehicle component that need not be removed in an operation of installing the first component in the vehicle, but becomes removable by the removal of a component in the operation of installing the first component. For example, in the operation of replacing the communication device described above, while an audio amplifier and a wireless charger need not be removed in order to remove the communication device to be replaced, these parts become removable with ease (in fewer steps) by the removal of the instrument panel. In this case, at least one of the audio amplifier and wireless charger may be removed as the second component.

In the information processing apparatus according to the embodiment, the second component may include a third sale item, which is a vehicle component that is removable by an operation different from the operation of installing the first component in the vehicle. For example, there can be a case where, at the time of replacement or installation of the communication device described above, the user wishes to remove unnecessary components from the vehicle, and sell them to reduce the cost of installing the first component. For example, there may be a case where a fender, wheel cover, lamp, antenna or the like is removed from the vehicle and sold. These components are removed in an operation different from (irrelevant to) the operation of installing the communication device. The second component may also include such components.

The information processing apparatus according to the embodiment may also adopt the following configuration. If it is determined that an alternative component of the first sale item is to be installed in the vehicle, the controller may offset the cost of installing the alternative component with a sale price of the first sale item. For example, there may be a case where the user wishes to install a component having the same function as the second component (alternative component), for example, when selling the second component. For example, there may be a case where it is desirable to prevent the vehicle from losing the function itself of the second component by the sale, or where it is required that the vehicle be equipped with that component. In these cases, the payment for the alternative component and the cost of installation (operation fee) are offset by the sale profit from the second component. The alternative component is for example a lower grade type of the second component. Here, the grade being lower is not an essential requirement.

The information processing apparatus according to the embodiment may also adopt the following configuration. The controller may determine whether or not a business transaction is possible with a pre-registered member that is a person who previously registered information indicating a wish to buy the second component, based on the information indicating a wish to buy, or based on a reply from the pre-registered member in response to an inquiry about an interest in purchasing the second component, the inquiry being made based on the information indicating a wish to buy. In this case, the controller may output information for inviting prospective buyers of the second component if it has determined that no business transaction can occur with the pre-registered member about the second component. Determination of whether or not a business transaction is possible may be made using information pre-registered by the pre-registered member indicating a wish to buy, or may be made by providing the pre-registered member with information inquiring about an interest in purchasing the second component and by receiving a reply. For speedy sale of the second component, it is desirable to pre-register prospective buyers of the second component (in advance). The pre-registered member may be supplied with information including, for example, sale price, desired delivery method (handover at the place where removal takes place, or shipping by a delivery company), and the date and time of visit to the place where the component is removed. If there are no pre-registered members, it is preferable to seek prospective buyers to help the user gain a profit by the sale.

The information processing apparatus according to the embodiment may also adopt the following configuration. If the controller determines that a buyer of the second component will visit a place where the second component is removed for pickup of the second component on the date when the second component is removed from the vehicle, the controller may calculate a sale price of the second component that is higher than a sale price of the second component in the case of shipping the second component to the buyer of the second component. If the buyer visits the place where the second component is removed on the date of removal, the cost required for storage and shipping of the second component can be cut. Therefore, the sale price in this case should preferably be higher than that in the case of shipping.

The information processing apparatus according to the embodiment may also adopt the following configuration. If the controller determines that there is no buyer of the second component until the date on which the second component is removed from the vehicle, the controller calculates a sale price of the second component based on the information indicating a degree of demand for the second component. The degree of demand can be calculated for example from the market rate (e.g., average) of the sale price of a component of the same type as the second component, and the number of dates it took from publication of the sales information until purchase. For example, possibilities of reaching a deal faster, which will come with higher demand despite a high sale price, may be presented. Namely, if the sale price is fixed, the degree of demand is the information indicative of how fast it is until a deal is reached. The longer the period, the higher the cost of storage and posting of the sales information. Therefore, the apparatus may adopt a configuration in which the controller calculates a lower sale price for a lower degree of demand.

The information processing apparatus according to the embodiment may also adopt the following configuration. The controller may adopt a configuration where it renews the operation sheet illustrating operations for installing the first component in accordance with the sale of the second component. This enables the operation of installing the first component to be carried out in an efficient procedure.

Hereinafter, an information processing apparatus, an information processing method, and a program according to one embodiment will be described with reference to the drawings. The configuration in the embodiment is merely an example. The present disclosure is not limited to the configuration of the embodiment.

Configuration of Information Processing System

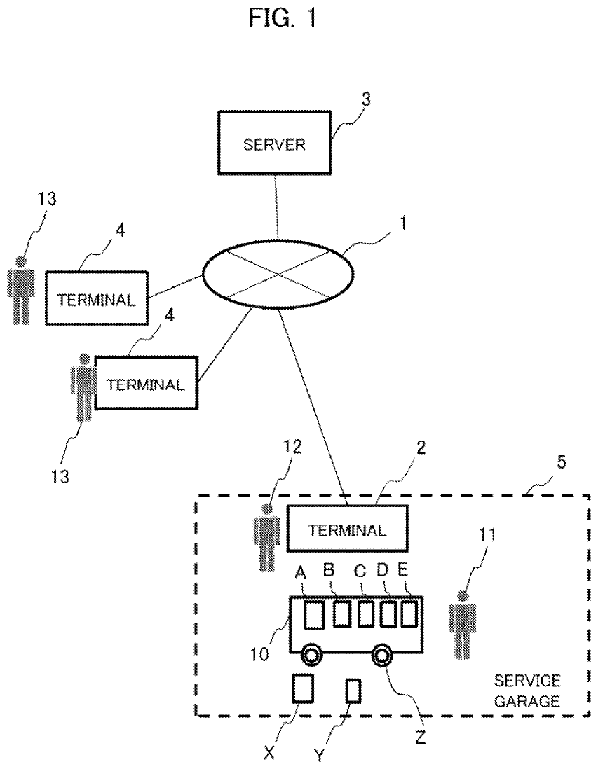

FIG. 1 is a schematic diagram of an information processing system according to the embodiment. In FIG. 1, the information processing system includes a network 1, a terminal 2 placed in a car service garage 5, and a server 3 and one or more terminals 4 each connected to the network 1. The terminal 2 is one example of “information processing apparatus.”

The network 1 is a public communication network such as Internet, for example, which provides communication lines to the terminal 2, server 3, and terminals 4. A wireless communication network may be connected to the network 1. The wireless communication network meets or conforms to a wireless communication standard available to the terminal 2. The wireless communication standard includes, for example, but not limited to, 4G (LTE: Long Term Evolution), 5G, wireless LAN (Local Area Network including Wi-Fi), BLE, and so on.

The terminal 2 is a device equipped in the service garage 5 for example and operated by an employee 12 at the service garage 5. The terminal 2 is used for creation of an operation sheet relating to installation of a component X (one example of first component) in a vehicle 10, as well as for calculation of the cost required for the installation of the component X. The terminal 2 may be a stationary terminal, or a portable terminal.

The vehicle 10 is an automobile (such as a car, truck, or bus). Components A, B, C, D, and Z are installed in the vehicle 10. The component D is the part to be replaced with the component X that is the part to be installed. The components A, B, and C are parts to be removed from the vehicle 10 in order to remove the component D. The component Y is an alternative component of the component C and going to be installed in the vehicle 10 in place of the component C. The component Z is installed in the vehicle 10 and will be removed from the vehicle 10 in an operation irrelevant to (different from) the operation for the installation of the component X.

For example, the components X and D are communication devices, the component A is an instrument panel, the component B is an audio amplifier, the components C and Y are wireless chargers, and the component Z is a tire wheel. These components are only examples.

The server 3 manages information relating to the transaction of each component. The server 3 is also used to publish the sales information of components removed from the vehicle 10. The terminals 4 are used by the users of the terminals 4. Users 13 of the terminals 4 are individuals who registered information indicating a wish to buy components in the server 3 beforehand (pre-registered members), or viewers of the sales information of components published by the server 3.

Configuration of Terminal

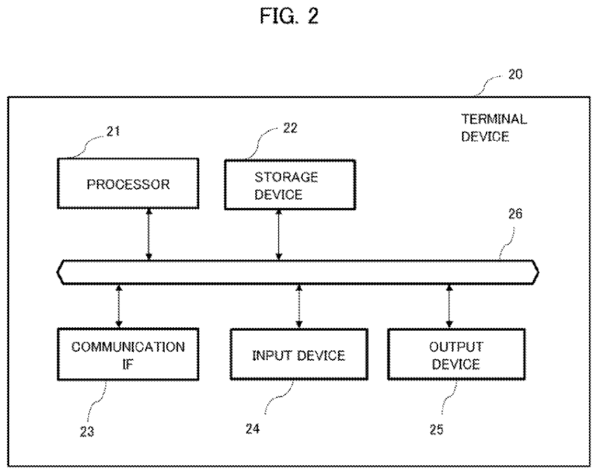

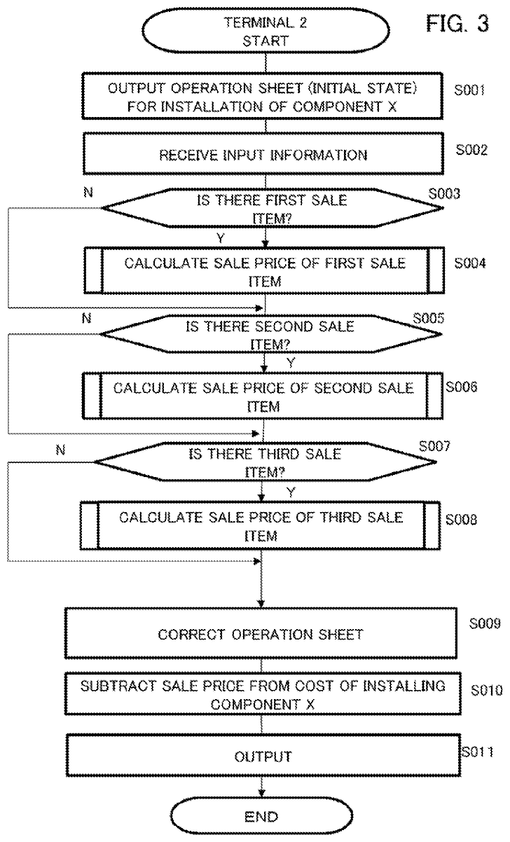

FIG. 2 is a diagram illustrating a configuration example of a terminal device 20 operable as the terminal 2, server 3, and terminal 4. The terminal device 20 may be configured, for example, by a general-purpose information processing apparatus (computer) such as a personal computer (PC) or work station, or a dedicated information processing apparatus such as a server machine. The terminal device 20 has communication functions and is connectable to the network 1 via wire or wirelessly.

In FIG. 2, the terminal device 20 includes a processor 21 as a processing unit or controller (controller), a storage device (memory unit) 22, a communication interface 23 (communication IF 23), an input device 24, and an output device 25, these being connected to each other via a bus 26. The server 3 may be one terminal device 20, or a collection of two or more terminal devices 20 (cloud).

The storage device 22 includes a main storage device and an auxiliary storage device. The main storage device is used as a program and data storage area, program deployment area, program work area, communication data buffer area, and so on. The main storage device is configured by a RAM (Random Access Memory), or a combination of a RAM and a ROM (Read Only Memory). The auxiliary storage device is used as a storage area of data and programs. For the auxiliary storage device, for example, non-volatile memory media such as a hard disk, SSD (Solid State Drive), flash memory, EEPROM (Electrically Erasable Programmable Read-Only Memory), and so on, may be applied.

The communication IF 23 is a circuit that performs communication processing and operates as a transmission unit and a reception unit (communication unit). For example, the communication IF 23 is a network interface card (NIC). The communication IF 23 may be a wireless communication circuit that performs wireless communications (such as LTE, 5G, wireless LAN (Wi-Fi), and BLE). The communication IF 23 may include both of a circuit that performs communication processing via wire and a wireless communication circuit.

The input device 24 includes keys, buttons, pointing devices, touchscreens and the like, and is used for the inputting of information. The input device 24 may include a microphone (sound input device). The output device 25 is for example a liquid crystal display or an organic EL display, and displays information and data. The output device 25 may include a speaker (sound output device).

The processor 21 is a CPU (Central Processing Unit) or the like, for example. The processor 21 performs various processing by executing a variety of programs stored in the storage device 22.

For example, the processor 21 of the terminal device 20 operating as the terminal 2 creates an operation sheet relating to installation of the component X in the vehicle 10, and calculates the sale price of the component. The processor 21 of the terminal device 20 operating as the server 3 performs processing relating to collection and management of the information that indicates the value of the component, and publication of the sales information of the component. The processor 21 of the terminal device 20 operating as the terminal 4 is used to obtain sales information from the server 3 and to send replies to the server 3 about the information regarding the purchase of the component.

A plurality of CPUs, or a multicore CPU, are both applicable as the processor 21 described above. At least part of the processing performed by the CPU may be assigned to other processors than the CPU such as a DSP (Digital Signal Processor) or a GPU (Graphical Processing Unit). At least part of the processing performed by the CPU may be executed by a dedicated or general-purpose integrated circuit (hardware) including ASIC (Application Specific Integrated Circuit) and FPGA (Field Programmable Gate Array), or a combination of a processor and an integrated circuit. Such a combination is referred to, for example, as a microcontroller (MCU), SoC (System-on-a-chip), system LSI, or chip set.

### Operation Example

FIG. 3 is a flowchart illustrating a processing example of the processor 21 of the terminal device 20 operating as the terminal 2. The processing illustrated in FIG. 3 is implemented by the processor 21 of the terminal 2 executing a program.

The terminal 2 is used by, for example, an employee 12 at a service garage 5, for discussing (making arrangements for) a service date for installation of the component X, and components to be removed from the vehicle 10 on the service date to be sold, with the user 11 of the vehicle 10.

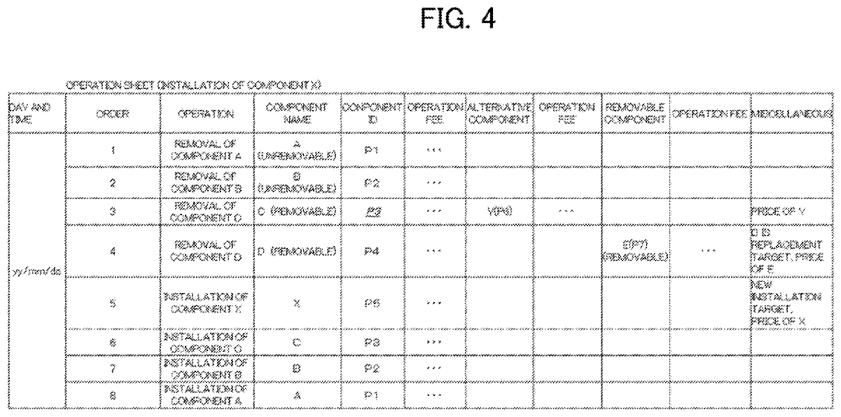

At step S001, the processor 21 outputs an operation sheet (initial state) for installing the component X in the vehicle 10. FIG. 4 illustrates a data structure example of the operation sheet stored in the storage device 22 of the terminal 2.

The operation sheet is designed for installation of the component X, in which are stored a date of service when the component X is installed in the vehicle 10 (component X installation date), order of operations, content of each operation, component names, component identification information (component ID), and operation fees for respective components. The operation sheet further stores the information indicating an alternative component of the component to be removed, information indicating the fee for this operation, information indicating a component that will become removable by the removal of another component (to be referred to as removable component) and the fee for this operation, and miscellaneous information. The miscellaneous information includes information indicating the respective prices of a new installation target, alternative component, and removable component, and attributes of the components (whether they are a replacement target or a new installation target).

The operation sheet is displayed on the output device 25 (display) of the terminal 2, and used to show to the user 11 of the vehicle 10 and to explain the operations and operation fees for the installation of the component X.

At step S002, the processor 21 of the terminal 2 receives information input via the input device 24. Namely, the employee 12 at the service garage 5 explains each operation while showing the operation sheet to the user 11. At this time, the processor 21 indicates on the display that it is necessary to remove the components A, B, C, and D in order to install the component X. The processor 21 also indicates on the display that, while the components A and B cannot be sold, the components C and D are sellable (components C and D can be candidates for sale), and requests an input of whether or not to sell each of the components C and D. The employee 12 inputs a reply from the user 11 to the terminal 2 using the input device 24. This embodiment assumes that the user 11 has decided to sell the components C and D. Here, the component C is one example of “second component” and “first sale item,” and the component D is one example of “component to be replaced.”

The processor 21 outputs, to the display, information inquiring the necessity for installation of an alternative component Y of the component C, and the necessity for removal and sale of a component E which will become removable by the removal of the component D. The component E is one example of “second component” and “second sale item.”

Further, the processor 21 outputs, to the display, information inquiring the necessity for removal of components irrelevant to the operation of installing the component X. This embodiment assumes that, in accordance with the wishes of the user 11 regarding these information, instructions have been input to the terminal 2 for installation of the component Y, removal and sale of the component E, and removal of a component Z to be carried out in a different operation from the operation for the installation of the component X. The component Z is one example of “second component” and “third sale item.” The information input at step S002 is stored in the storage device 22. The operation sheet stores information indicating components to be sold. For example, in the example shown in FIG. 4, the component IDs of the components C and E are shown in italics and bold, and the component ID of the component D is shown in italics. In actuality, a flag indicating sale is set to each of the components to be sold.

At step S003, the processor 21 of the terminal 2 determines whether or not a first sale item is included in the components to be sold. If it is determined that a first sale item is included, the process goes to step S004, while, if not, the process goes to step S005.

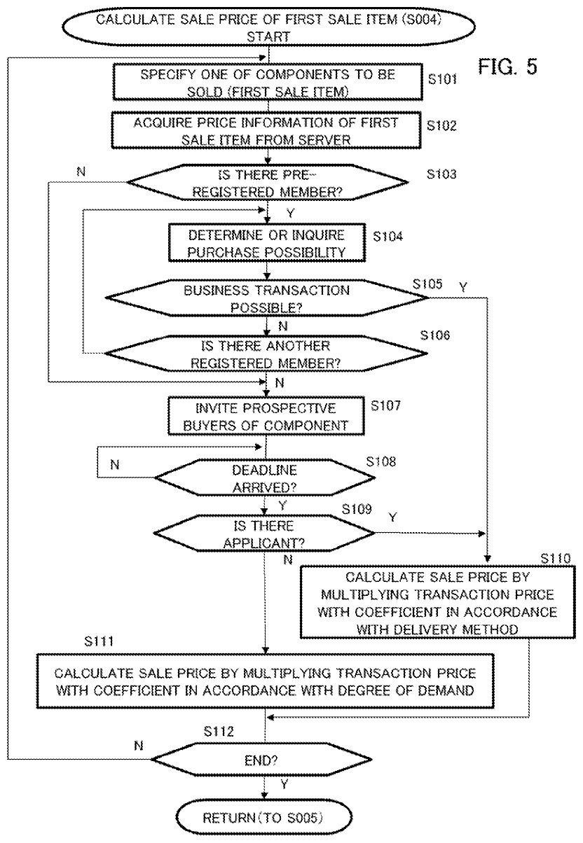

At step S004, the processor 21 of the terminal 2 executes processing (subroutine) for calculating a sale price of the first sale item. FIG. 5 is a flowchart illustrating an example of processing for calculating a sale price of the first sale item.

In FIG. 5, at step S101, the processor 21 of the terminal 2 looks up the operation sheet (FIG. 4) and specifies one or more first sale items. At step S102, the price information of the first sale item(s) specified at step S101 is acquired from the server 3.

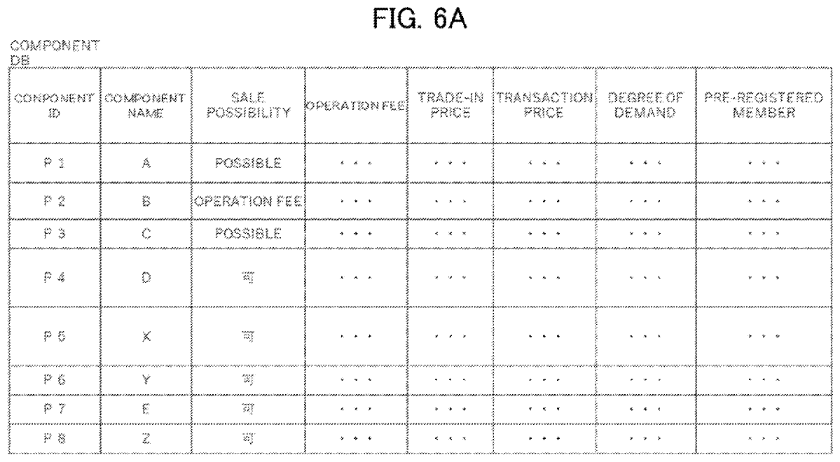

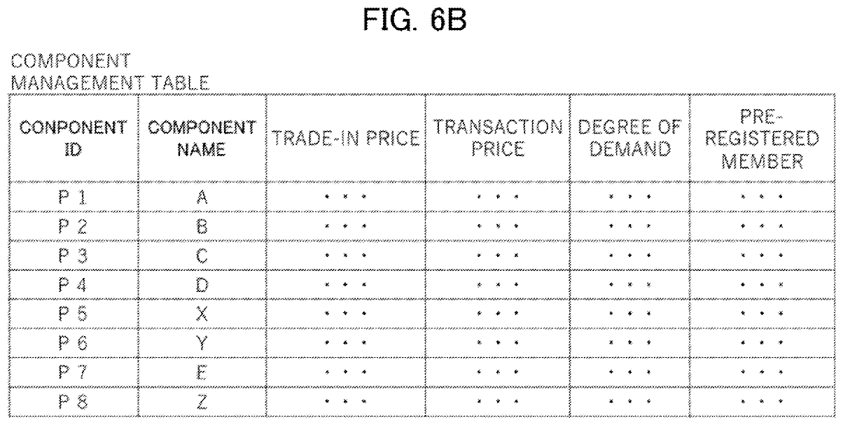

The storage device 22 of the terminal 2 stores the component database (component DB) illustrated in FIG. 6A. The component DB is comprised of records (entries) for respective component IDs, each record including a component name, sale possibility, operation fee, trade-in price, transaction price, degree of demand, and pre-registered member information.

The component name is the name or the like of the component. The sale possibility indicates the possibility of sale of a component to be removed. In this embodiment, sale of the components A and B is prohibited, and sale of the components C and D is permitted. The sale possibility may be determined as required. For example, sale of components that are not designed to be installed again, or components that are to be disposed of because of inevitable deterioration such as deformation caused by the removal, is not allowed. The operation fees indicate the fees required for the operations for removal and installation of target components.

The trade-in price indicates the price of a component purchased by the service garage 5. The transaction price indicates an average value of sale prices of the component in an auction site or online shopping site for second hand items. The degree of demand is information that provides a rough indication of how quickly a deal can be reached, and ranges from 0 to 1, inclusive. The pre-registered member information is information registered in the server 3 by one or more individuals who wish to buy a target component, and includes a component ID, and personal information (name and contact information) of the pre-registered member(s).

The information of the trade-in prices, transaction prices, degrees of demand, and pre-registered members is managed in a component management table (see FIG. 6B) stored in the storage device 22 of the terminal device 20 operating as the server 3. The terminal 2 accesses the server 3 via the network 1 and sends a request for supply of information (information indicating the value) about a component ID registered in the component DB of the terminal 2 (data request). The server 3 reads out the information corresponding to the data request from the component management table and sends it to the terminal 2. The processor 21 of the terminal 2 stores the information received from the server 3 in the component DB.

At step S102, the processor 21 of the terminal 2 reads out the component ID of the component C that is the first sale item from the operation sheet, generates a data request containing the component ID of this component C, and sends it to the server 3. After that, the terminal 2 receives a record of the component C in the component management table from the server 3, as the response to the data request. The processor 21 of the terminal 2 stores the record received from the server 3 as the record of the component C in the component DB.

At step S103, the processor 21 of the terminal 2 looks up the record of the component C in the component DB to determine whether or not there is information on pre-registered members. If it is determined that there is information on pre-registered members, the process goes to step S104, while, if not, the process goes to step S107.

At step S104, it is determined whether or not one of the pre-registered members selected according to predetermined rules is able to buy. The information on the pre-registered member selected at step S104 may sometimes include information on the range of permissible purchase prices, a desirable delivery method (pickup by a visit to the service garage 5, or by shipping), and an available pickup date and time. In this case, the processor 21 determines whether or not these are in line with the date and time of removal and the transaction price of the component C in the operation sheet (step S105). The processor decides that the component C is to be sold to this pre-registered member if it determines that the range of the purchase prices and the available pickup date and time are in line with the transaction price and the date and time of removal, and that the desired delivery method is shipping and the purchase price is in line with the transaction price. In this case, the process proceeds to step S110. If it is decided at step S105 that the component C is not to be sold, i.e., if it is determined that no business transaction is possible, the process goes to step S106.

On the other hand, if, at step S104, it is not possible to determine from the information on the pre-registered member whether or not the pre-registered member is able to buy, the processor 21 sends a message inquiring about an interest in purchasing the component C to the terminal 4 of the pre-registered member. The message includes information on a transaction price, an address of the service garage 5, an available date and time for pickup, a transaction price for shipping, and a deadline for response. The user 13 of the terminal 4, seeing the message, can generate a reply message including information indicating whether or not the user wishes to buy, and a delivery method (pickup or shipping), and send it to the terminal 2.

If a message is received by the terminal 2 before the deadline for response, the processor 21 of the terminal 2 determines at step S105 whether or not the reply indicates a wish to buy. If the reply indicates a wish to buy, it is determined that a business transaction is possible, and the process proceeds to step S110. If the reply does not indicate a wish to buy, or if it is determined that no reply was received before the deadline for response, the process goes to step S106.

At step S106, the processor 21 determines whether or not there remains another pre-registered member. If it is determined that there remains another pre-registered member, the process returns to step S104, while, if not, the process proceeds to step S107.

At step S107, the processor 21 of the terminal 2 sends a message to the server 3, asking to publish (advertise) information relating to the purchase of the component C. The server 3 manages a website showing transaction prices and delivery methods of components to be sold, and the server posts the information on the component C to the website. Alternatively, the server may send the information on the component C to one or more terminals 4 via SMS, e-mail, or in other message formats.

At step S108, the processor 21 of the terminal 2 waits until the deadline for a response from users 13 of the terminals 4, and determines at step S109 whether or not there are applicants who have reacted to the transaction price and delivery method shown in the information on the component C. At step S109, if it is determined that there are applicants, the processor 21 of the terminal 2 selects one of the applicants according to predetermined rules to sell the component C to, determines that a business transaction is possible and proceeds the process to step S110. If not, the process goes to step S111.

At step S110, the processor of the terminal 2 calculates the sale price of the component C by multiplying the transaction price with a coefficient in accordance with the delivery method. The value of the coefficient is 1, for example, for the case where the buyer visits the service garage 5 on the designated date and time to pick up the component C. If shipping of the component C is desired, the value of the coefficient is set smaller than the value for when it is to be picked up (=1). This makes the sale price of the component to be picked up higher than that of the component to be shipped.

At step S111, the processor 21 of the terminal 2 calculates the sale price by multiplying the transaction price with a coefficient in accordance with a degree of demand. The coefficient corresponding to the maximum degree of demand is 1, which reduces in proportion to the degree of demand. The degree of demand itself may be used as the coefficient, or another coefficient corresponding to the degree of demand may be provided. When the value of the degree of demand is lower than a certain level, the sale price is made equal to the trade-in price (minimum sale price).

At step S112, the processor 21 determines whether or not calculation of the sale price is finished for all of the first sale items. The sale price of the component to be replaced (in this embodiment, component D), which is not categorized as the first sale item, can be calculated by using the subroutine of step S004. Alternatively, step S006 or S008 to be described later may be used.

When step S112 ends, the process returns to step S005 (FIG. 3), where the processor 21 determines whether or not there is a second sale item. If it is determined that there is a second sale item, the processor 21 calculates a sale price of the second sale item at step S006. In this embodiment, since there is the component E that is a second sale item, the processing at step S006 is executed.

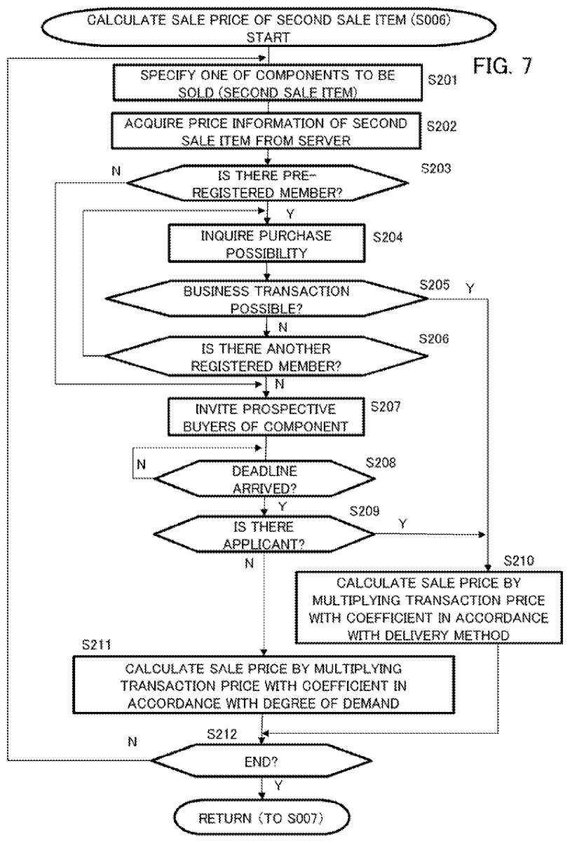

FIG. 7 is a flowchart illustrating an example of processing for calculating a sale price of the second sale item. The processing steps S201 to S212 are the same as the processing steps S101 to S112 except that the first sale item is the second sale item. Therefore a detailed description of the processing steps S201 to S212 will be omitted.

When step S212 ends, the process returns to step S007 (FIG. 3), where the processor 21 determines whether or not there is a third sale item. If it is determined that there is a third sale item, the processor 21 calculates a sale price of the third sale item at step S008. In this embodiment, since there is the component Z that is a third sale item, the processing at step S008 is executed.

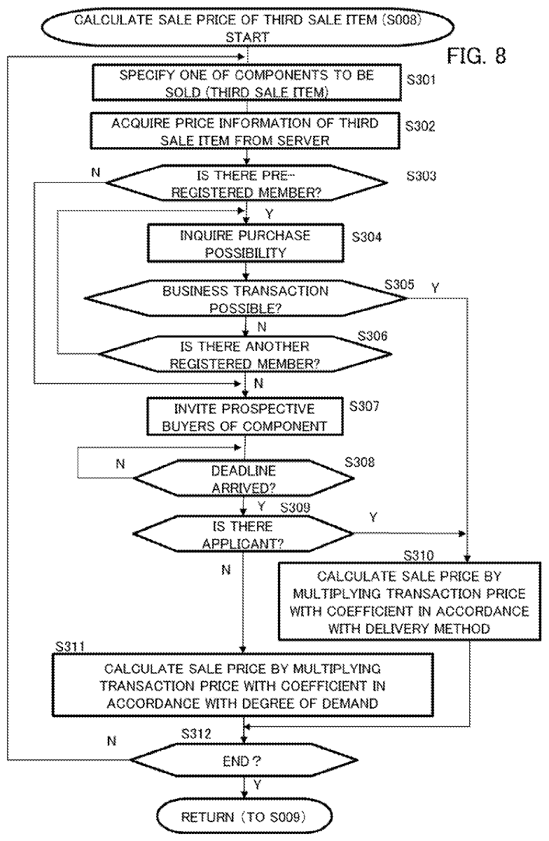

FIG. 8 is a flowchart illustrating an example of processing for calculating a sale price of the third sale item. The processing steps S301 to S312 are the same as the processing steps S101 to S112 except that the first sale item is the third sale item. Therefore a detailed description of the processing steps S301 to S312 will be omitted.

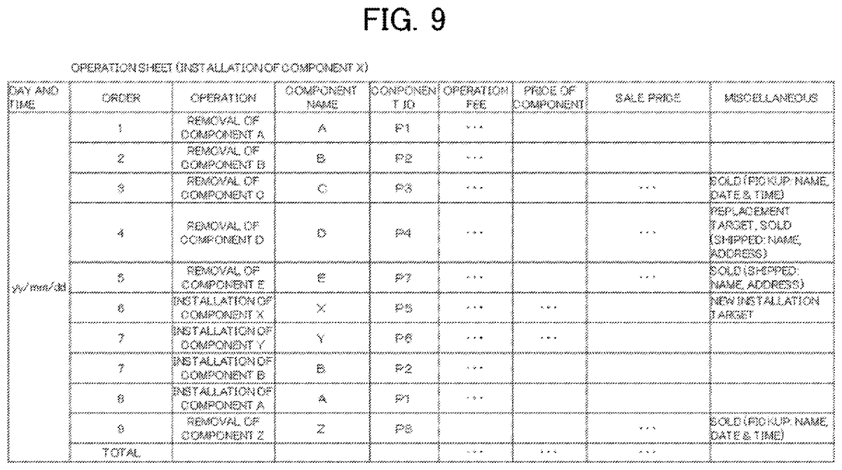

When step S312 ends, the process returns to step S009 (FIG. 3), where the processor 21 corrects the operation sheet. FIG. 9 is a diagram illustrating an example of the operation sheet that has been corrected.

As shown in FIG. 9, the processor 21 makes corrections to add the information indicating the sale method of the component C that is a first sale item (delivery mode: pickup, name, and pickup date and time) in the miscellaneous field of the operation for the removal of the component C. In the miscellaneous field of the operation for the removal of the component D that is to be replaced is added the information indicating the sale method of the component D (delivery mode: shipping, name, and address). An operation for removing the component E that is a second sale item is added to the operation sheet. In the miscellaneous field of this operation is added the information indicating the sale method of the component E (delivery mode: shipping, name, and address). An operation for removing the component Z that is a third sale item is added to the operation sheet. In the miscellaneous field of this operation is added the information indicating the sale method of the component Z (delivery mode: pickup, name, and date and time).

When there are a second sale item and a third sale item, the operations of removing these items are added to the operation sheet, with the information indicating the sale methods of respective sale items being added to the miscellaneous fields. The rows indicating alternative components and removable components are deleted. The processor 21 also calculates the total sum of the operation fees for the operations (operations 1 to 10) in the operation sheet and records it in the operation sheet. The processor 21 also calculates respective component prices of the components X and Y to be newly installed in the vehicle 10, the total sum of these prices, the sale prices of the components C, E, and Z that are the first to third sale items, the sale price of the component D to be replaced, and the total sum of these sale prices, and records these in the operation sheet. The total sum of the operation fees plus the total sum of the component prices indicate the cost for the installation of the component X. The processor 21 subtracts (reduces) the total sum of sale prices from the amount of this cost (step S010). If the result of subtraction of the total sum of sale prices from the total sum of operation fees is a negative value, the total sum of the component prices may be reduced by this negative value, or vice versa. In other words, the sale price may be subtracted from at least one of the operation fee and the component price. The cost of installing the alternative component is offset by the sale price of the second component. The processor 21 then outputs (displays) the costs for the installation of the component X to the output device 25 (display) (step S011).

Advantageous Effects of Embodiment

The controller (processor 21) of the information processing apparatus (terminal 2) according to the embodiment calculates the sale price of the second component based on the information indicating the value of the second component (information stored in the record of each component in the component DB). The second component is one of the components C and D bound to be removed from the vehicle 10 when installing the first component X in the vehicle 10, the component C, which is not the component D that is the part to be replaced with the first component X. The second component may also be a component C that is bound to be removed from the vehicle 10 when the first component X is installed in the vehicle 10, in a case where there is no component D already installed in the vehicle 10 to be replaced with the first component X. The processor 21 of the terminal 2 subtracts the sale price of the second component from the cost of installing the first component (at least one of the operation fee and the component price). This way, the cost for the installation of the first component X can be reduced, which helps encourage installation of the first component X.

In the embodiment, the second component includes a first sale item (component C), which is a component to be removed from the vehicle 10 in the operation of installing the first component X in the vehicle 10. The second component includes a second sale item (component E), which is a component of the vehicle 10 that need not be removed in the operation of installing the first component X in the vehicle 10, but becomes removable by the removal of the component D in the operation of installing the first component X. Further, the second component includes a third sale item (component Z), which is a component of the vehicle 10 that is removable by an operation different from the operation of installing the first component X in the vehicle 10. Selling the second and third sale items in addition to the first sale item can further reduce the cost of installing the first component X.

When an alternative component Y of the first sale item is to be installed in the vehicle 10, the processor 21 of the terminal 2 offsets the cost of installing the alternative component Y (operation fee and component price) with the sale price of the first sale item (S010 in FIG. 3). This way, the alternative component can be installed more inexpensively by the sale profit from the second component (at least one of the first to third sale items).

The processor 21 of the terminal 2 determines whether or not a business transaction is possible with a pre-registered member that is a person who previously registered information indicating a wish to buy the second component (pre-registered member information), based on the information indicating a wish to buy. The processor 21 can alternatively determine whether or not a business transaction is possible with a pre-registered member based on a reply from the pre-registered member in response to an inquiry, made on the basis of the information indicating a wish to buy, about an interest in purchasing the second component. When the processor 21 determines that no business transaction is possible with the pre-registered member about the second component, the processor outputs information for inviting prospective buyers of the second component (sends the information to the terminal 4). This way, the sale of the second component can be assisted.

The processor 21 of the terminal 2 calculates a sale price of the second component that is higher than the sale price of the second component in the case of shipping the second component to the buyer of the second component, if the buyer of the second component is to visit the place where the second component is removed (service garage 5) for pickup of the second component. This way, the sale price of the component to be picked up can be made higher than that of the component to be shipped.

The processor 21 of the terminal 2 calculates the sale price of the second component based on the information indicating the degree of demand for the second component, if there is no buyer of the second component until the date on which the second component is removed from the vehicle 10. This way, the sale price can be calculated such that the higher the degree of demand for the second component (the faster until a deal is reached), the higher the sale price.

The processor 21 of the terminal 2 renews the operation sheet illustrating operations for installing the first component in accordance with the calculation of the sale price of the second component (see FIG. 9). This way, the cost for the installation of the first component X and respective sale prices of second components are recorded, to allow calculation of the cost minus the sale price.

Others

The embodiment described above is merely an example and the present disclosure can be carried out with various changes made as required without departing from the subject matter of the disclosure. The processing performed by one unit in the description above may be divided and separately executed by several units. Or, the processing performed by different units in the description above may be executed by one unit. The hardware configuration (server configuration) for implementing various functions of a computer system is flexibly changeable.

The present disclosure can also be implemented by supplying a computer with a computer program in which the functions described above in the embodiment are mounted, which is read out and executed by one or more processors of this computer. Such a computer program may be provided to the computer via a non-transitory computer-readable storage medium connectable to a system bus of the computer, or may be provided to the computer via a network. The non-transitory computer-readable storage medium may be a disc of any suitable type such as, for example, a magnetic disc (floppy (registered trademark) disc or hard disk drive (HDD)), and optical disc (CD-ROM, DVD disc, Blue-ray disc). The non-transitory computer-readable medium also includes a read-only memory (ROM), random access memory (RAM), EPROM, EEPROM, magnetic card, flash memory, optical card, or any type of medium suitable for storing electronic commands.

What is claimed is:

1. An information processing apparatus comprising:
a controller configured to:
calculate a sale price of a second component selected to be sold by a user of a vehicle, based on information indicating a value of the second component; and
subtract the sale price of the second component from a cost of installing a first component, the second component being either a component bound to be removed from the vehicle when installing the first component in the vehicle other than a component to be replaced with the first component, or a component bound to be removed from the vehicle when the first component is installed in the vehicle in a case where there is no component to be replaced with the first component in the vehicle.

2. The information processing apparatus according to claim 1, wherein the second component includes a first sale item, which is a component to be removed from the vehicle in an operation of installing the first component in the vehicle.

3. The information processing apparatus according to claim 1, wherein the second component includes a second sale item, which is a component of the vehicle that need not be removed in an operation of installing the first component in the vehicle, but becomes removable by removal of a component in the operation of installing the first component.

4. The information processing apparatus according to claim 1, wherein the second component includes a third sale item, which is a component of the vehicle that is removable by an operation different from an operation of installing the first component in the vehicle.

5. The information processing apparatus according to claim 2, wherein, when an alternative component of the first sale item is to be installed in the vehicle, the controller offsets a cost of installing the alternative component with a sale price of the first sale item.

6. The information processing apparatus according to claim 1, wherein the controller determines whether or not a business transaction is possible with a pre-registered member that is a person who previously registered information indicating a wish to buy the second component, based on the information indicating a wish to buy, or based on a reply from the pre-registered member in response to an inquiry about an interest in purchasing the second component, the inquiry being made based on the information indicating a wish to buy.

7. The information processing apparatus according to claim 6, wherein, if the controller determines that no business transaction is possible with the pre-registered member about the second component, the controller outputs information for inviting prospective buyers of the second component.

8. The information processing apparatus according to claim 1, wherein, if a buyer of the second component is to visit a place where the second component is removed for pickup of the second component, the controller calculates a sale price of the second component that is higher than a sale price of the second component in a case of shipping the second component to the buyer of the second component.

9. The information processing apparatus according to claim 1, wherein, if there is no buyer of the second component until a date on which the second component is removed from the vehicle, the controller calculates a sale price of the second component based on information indicating a degree of demand for the second component.

10. The information processing apparatus according to claim 1, wherein the controller renews an operation sheet illustrating an operation of installing the first component in accordance with a calculation of a sale price of the second component.

11. An information processing method of an information processing apparatus, the method comprising:
calculating, by the information processing apparatus, a sale price of a second component selected to be sold by a user of a vehicle, based on information indicating a value of the second component; and
subtracting the sale price of the second component from a cost of installing a first component, the second component being either a component bound to be removed from the vehicle when installing the first component in the vehicle other than a component to be replaced with the first component, or a component bound to be removed from the vehicle when the first component is installed in the vehicle in a case where there is no component to be replaced with the first component.

12. The information processing method according to claim 11, wherein the second component includes a first sale item, which is a component to be removed from the vehicle in an operation of installing the first component in the vehicle.

13. The information processing method according to claim 11, wherein the second component includes a second sale item, which is a component of the vehicle that need not be removed in an operation of installing the first component in the vehicle, but becomes removable by removal of a component in the operation of installing the first component.

14. The information processing method according to claim 11, wherein the second component includes a third sale item, which is a component of the vehicle that is removable by an operation different from an operation of installing the first component in the vehicle.

15. The information processing method according to claim 12, wherein, when an alternative component of the first sale item is to be installed in the vehicle, the information processing apparatus offsets a cost of installing the alternative component with a sale price of the first sale item.

16. A non-transitory computer-readable medium storing a program that causes a computer to execute:
calculating a sale price of a second component selected to be sold by a user of a vehicle, based on information indicating a value of the second component; and
subtracting the sale price of the second component from a cost of installing a first component, the second component being either a component bound to be removed from the vehicle when installing the first component in the vehicle other than a component to be replaced with the first component, or a component bound to be removed from the vehicle when the first component is installed in the vehicle in a case where there is no component to be replaced with the first component in the vehicle.

17. The non-transitory computer-readable medium according to claim 16, wherein the second component includes a first sale item, which is a component to be removed from the vehicle in an operation of installing the first component in the vehicle.

18. The non-transitory computer-readable medium according to claim 16, wherein the second component includes a second sale item, which is a component of the vehicle that need not be removed in an operation of installing the first component in the vehicle, but becomes removable by removal of a component in the operation of installing the first component.

19. The non-transitory computer-readable medium according to claim 16, wherein the second component includes a third sale item, which is a component of the vehicle that is removable by an operation different from an operation of installing the first component.

20. The non-transitory computer-readable medium according to claim 17, wherein, when an alternative component of the first sale item is to be installed in the vehicle, the program causes the computer to execute a step of offsetting a cost of installing the alternative component with a sale price of the first sale item.
